(19) United States
(12) Patent Application Publication
(10) Pub. No.: US 2014/0060872 A1
(43) Pub. Date: Mar. 6, 2014

(54) ROTATABLE LEVER STRUCTURE OF A PNEUMATIC TOOL AND PNEUMATIC TOOL INCLUDING THE SAME

(71) Applicant: HYPHONE MACHINE INDUSTRY CO., LTD., Taichung City (TW)

(72) Inventors: Chih-Ming TING, Taichung City (TW); Tien LIN, Taichung City (TW); Po-Jen LAI, Taichung City (TW)

(73) Assignee: HYPHONE MACHINE INDUSTRY CO., LTD., Taichung City (TW)

(21) Appl. No.: 13/709,896

(22) Filed: Dec. 10, 2012

(30) Foreign Application Priority Data
Aug. 31, 2012 (TW) 101216830

(51) Int. Cl. B25F 5/02

(52) U.S. Cl. CPC B25F 5/02
USPC 173/218; 173/168

(57) ABSTRACT

A rotatable lever structure of a pneumatic tool and a pneumatic tool including the same are provided. The rotatable lever structure is mounted to a main body of the pneumatic tool. The main body has a first portion and a second portion. The first portion is arranged with a lever and an entrance passage for pressurized air. A connection mechanism is detachably mounted to the second portion, and the first portion and the second portion are relatively rotatably connected via the connection mechanism. Whereby, the lever can be selectively rotated relative to the second portion, and is easy to use and less limited for various working environments.

### BACKGROUND OF THE INVENTION

1. Field of the Invention

The present invention relates to a rotatable lever structure of a pneumatic tool and a pneumatic tool including the same.

2. Description of the Prior Art

A conventional grinding machine is used to grind a surface of a workpiece by using a grinding disc thereof, wherein compressed gas is used to drive a pneumatic motor of the grinding machine to drive the grinding disc rotating for polishing or lapping. Generally, the grinding disc is mounted at a front end of a power output shaft of the grinding machine.

A flat grinding surface of the grinding disc has to be used to grind, polish or lap the surface of the workpiece to be ground; however, the power output shaft and a drive mandrel disposed in a main body of the grinding machine are perpendicular to each other and in a rotational operative relationship, that is, the grinding surface of the grinding disc is perpendicular to a radial direction of the main body. Besides, the lever of the grinding machine is fixedly disposed on a side opposite the grinding surface, and the position of the lever is not adjustable. As such, as there exists obstruction for pressing the lever in the working environment (such as there is a nonsufficient operation space over the lever, or there exists limitation of operation angle for grinding a surface of a workpiece to be ground or limitation of operation space), it is hard to conveniently and effectively press the lever, and hence the grinding machine will be operated in an inadequate operation angle relative the surface of the workpiece to be ground. As such, the grinding process is unsmooth and ineffective.

The present invention is, therefore, arisen to obviate or at least mitigate the above mentioned disadvantages.

### SUMMARY OF THE INVENTION

An object of the present invention is to provide a rotatable lever structure of a pneumatic tool and a pneumatic tool including the same, in which a lever of the pneumatic tool can be selectively rotated, and is easy to use and less limited for various working environments.

To achieve the above and other objects, a rotatable lever structure of a pneumatic tool is provided. The rotatable lever structure is adapted to be mounted to a main body of the pneumatic tool. The main body has a first portion and a second portion. The first portion is arranged with a lever and an entrance passage for pressurized air. A connection mechanism detachably is mounted to the second portion, and the first portion and the second portion are relatively rotatably connected via the connection mechanism.

To achieve the above and other objects, a pneumatic tool includes one of the above rotatable lever structure, a main body, a rotor and a tool assembly. The main body has a first portion and a second portion. The first portion is arranged with a lever and an entrance passage for pressurized air. A cylinder is mounted to the second portion. The rotor is rotatably disposed in the cylinder. The tool assembly is rotatably received in the second portion of the main body and in a rotational operative relationship with the rotor. A connection mechanism is detachably mounted to the second portion, and the first portion and the second portion are relatively rotatably connected via the connection mechanism.

Since the first portion and the second portion are relatively rotatably connected, the lever can be selectively rotated relative to the second portion, and is easy to use and less limited for various working environments.

Furthermore, the first portion and the second portion may be connected with each other via at least one insert and are rotatable relative to each other, thus resulting in a simple structure and facilitating assembling and disassembling.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of a pneumatic tool having a rotatable lever structure according to a preferred embodiment of the present invention;

FIG. 2 is a breakdown drawing of a pneumatic tool having a rotatable lever structure according to a preferred embodiment of the present invention;

FIGS. 3 and 4 are cross-sectional views of a pneumatic tool having a rotatable lever structure according to a preferred embodiment of the present invention; and

FIG. 5 is a drawing showing the operation of a rotatable lever structure according to a preferred embodiment of the present invention.

### DETAILED DESCRIPTION OF THE PREFERRED EMBODIMENTS

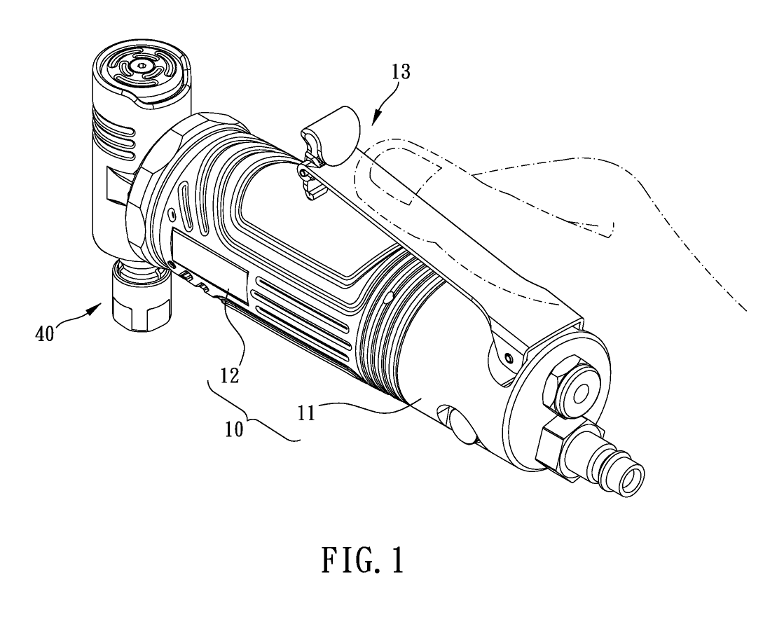

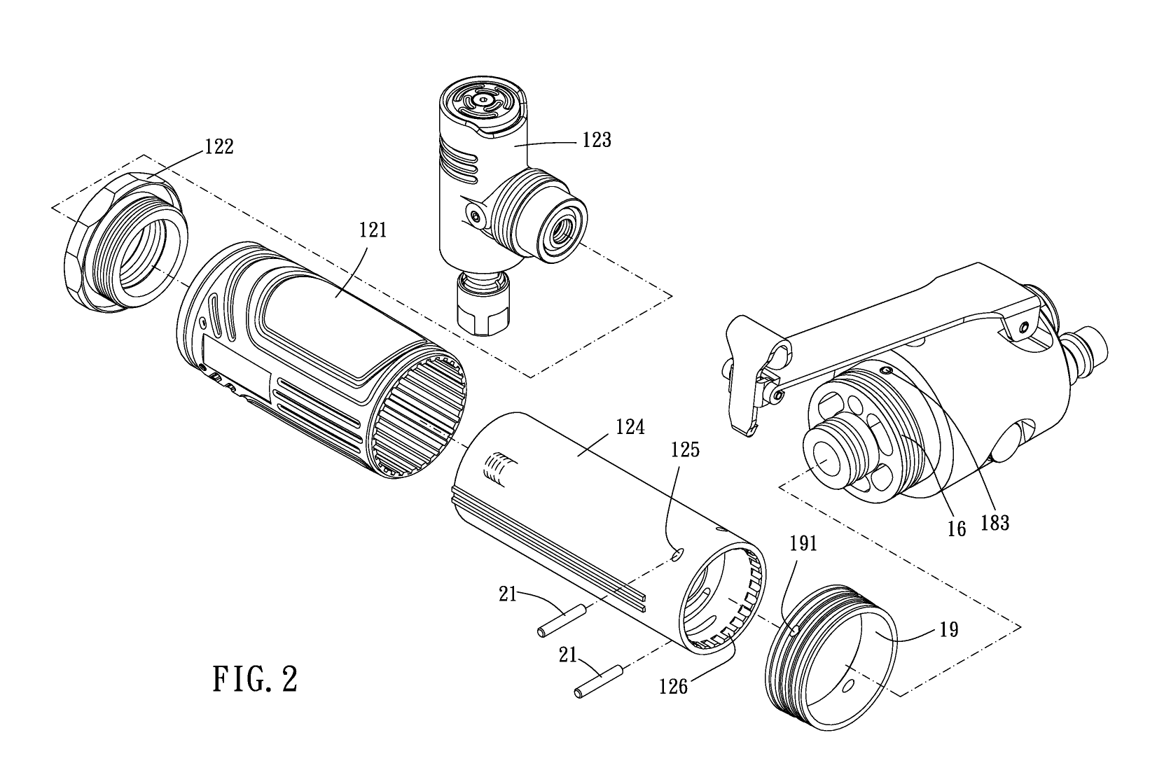

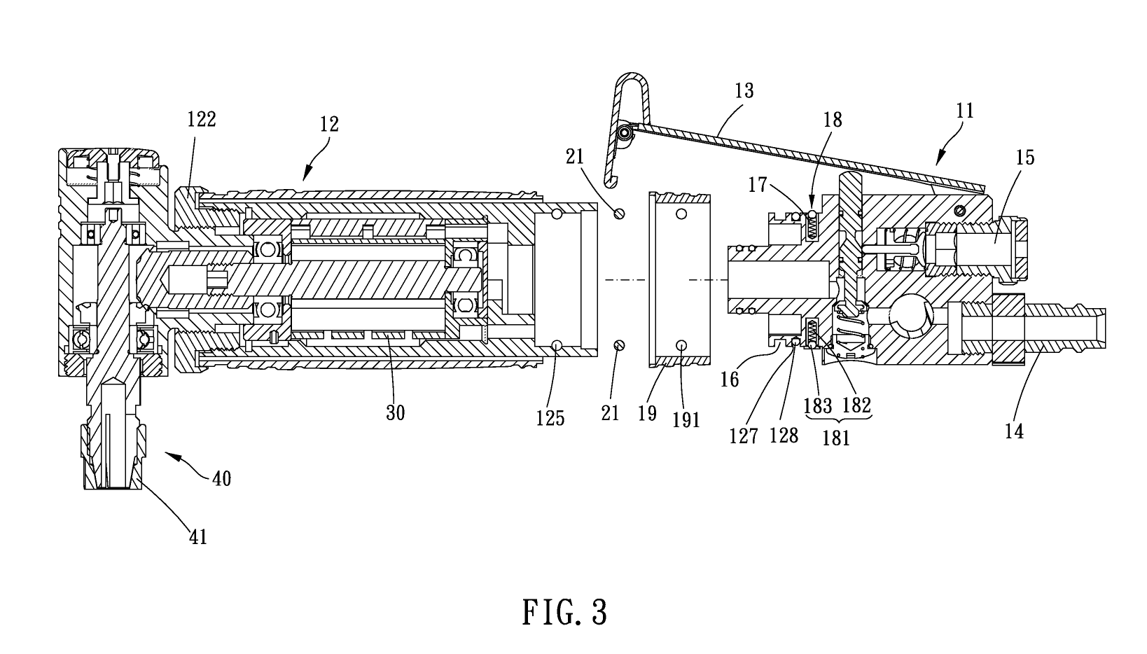

As shown in FIGS. 1 to 4, a rotatable lever structure of a pneumatic tool and a pneumatic tool including the same according to a preferred embodiment of the present invention are provided. The pneumatic tool includes a main body 10, a connection mechanism, a rotor 30 and a tool assembly 40. The pneumatic tool such as, but is not limited to, an air screwdriver, air wrench, air drill, air pull setter, or air sander. An air screwdriver is taken as an example in the following embodiment.

The rotatable lever structure is mounted to the main body 10 of the pneumatic tool. The main body 10 has a first portion 11 and a second portion 12. One end of the first portion 11 is arranged with a lever 13 and an entrance passage 14 and an exhaust passage 15 for pressurized air, and an outer circumferential surface of the other end of the first portion 11 is formed with an annular groove 16, two blind holes 17 and a stuck mechanism 18.

The second portion 12 includes a housing 121, a connection ring 122 and a tubular member 123. A cylinder 124 is disposed in the housing 121, and the connection ring 122 is detachably connected to one end of the cylinder 124. The connection ring 122 is secured to one end of the housing 121 so that the cylinder 124 is secured and does not move away from the housing 121 toward the first portion 11. A radially-extending portion of the tubular member 123 is disposed through the connection ring 122 and screwed to the connection ring 122, for example. An axial direction of the tubular member 123 is substantially perpendicular to an axial direction of the housing 121. At least one pair of first through holes 125 radially penetrate a circumferential wall of the other end of the cylinder 124. More specifically, two corresponding pairs of the first through holes 125 radially penetrate the circumferential wall of the other end of the cylinder 124. The cylinder 124 defines a gas chamber, and the entrance passage 14 and the exhaust passage 15 are communicated pneumatically with the gas chamber. Through pressing the lever 13 to control a vale member to selectively communicate the passages, the pressurized air is allowed to come into the gas chamber so as to drive the rotor 30.

A plurality of separate recesses 126 are arranged around on an inner circumferential surface of one end of the second portion 12. The stuck mechanism 18 is radially movably stuck in at least one of the recesses 126. In this embodiment, the recesses 126 are arranged around on an inner circumferential surface of the other end of the cylinder 124. The stuck mechanism 18 includes two stuck assemblies 181, and each stuck assembly 181 includes an elastic member 182 (such as a helical spring) and a stuck member 183 (such as a steel ball). The elastic member 182 is received in the blind hole 17 and urges the stuck member 183 to be stuck in one of the recesses 126. It is noted that either of the amounts of the blind hole 17 and the stuck assembly 181 may be one or more than two. Additionally, the structure of the stuck mechanism 18 is not limited to as the aforementioned one, and any structure which can be radially movably, radially deformably or radially retractably stuck in at least one of the recesses 126 may be applied.

Preferably, the second portion 12 further includes a sleeve 19 disposed around the cylinder 124, and at least one pair of second through holes 191 radially penetrate a circumferential wall of the sleeve 19. More specifically, two corresponding pairs of the second through holes 191 radially penetrate the circumferential wall of the sleeve 19. The sleeve 19, the first portion 11 and the second portion 12 may be made of the same material such as metal; however, the sleeve 19 may be made of a material, such as plastic or the like, which is grab-proof or/and slip-proof.

The connection mechanism is detachably mounted to the second portion 12 and partially radially blocked in the annular groove 16. The connection mechanism includes at least one insert 21 disposed through the first through holes 125 and partially radially blocked in the annular groove 16. More specifically, the connection mechanism includes two of the inserts 21, each of the inserts 21 is disposed through the corresponding first through holes 125 and second through holes 191 and partially radially blocked in the annular groove 16. As such, the first portion 11 is limited by the two inserts 21 and rotatable between the two inserts 21 so that the first portion 11 and the second portion 12 are relatively rotatably connected via the connection mechanism. One end edge of the sleeve 19 abuts against one end edge of the housing 121 of the second portion 12, the other end edge of the sleeve 19 is substantially aligned with one end edge of the cylinder 124, and preferably, there exists a narrow gap between the first portion 11 and the other end edge of the sleeve 19 to facilitate relative rotation of the first portion 11 and the second portion 12.

Preferably, in this embodiment, the outer circumferential surface of the first portion 11 is further formed with an annular trench 127, and an 0-ring 128 is disposed in the annular trench 127 and between the outer circumferential surface of the first portion 11 and the inner circumferential surface of the cylinder 124 so that the first portion 11 and the cylinder 124 are gastightly sealed.

The rotor 30 is rotatably disposed in the cylinder 124 and received in the gas chamber. The pressurized air can be led into the gas chamber to drive the rotor 30 rotating, and the pressurized air then exhausts via the exhaust passage 15.

The tool assembly 40 is rotatably received in the tubular member 123 of the second portion 12 of main body 10 and in a rotational operative relationship with the rotor 30. More specifically, the tool assembly 40 is received in a tool receiving space of the main body 10 and rotatable relative to the main body 10. The tool assembly 40 may include a tool head 41 extending out of the tubular member 123 for a connection of the tool head 41 with a workpiece or a tool. The tool assembly 40 is connected to and in a rotational operative relationship with the rotor 30. In an alternative embodiment, the tool assembly 40 may be replaced by any other tool assembly which can drive the workpiece or the tool.

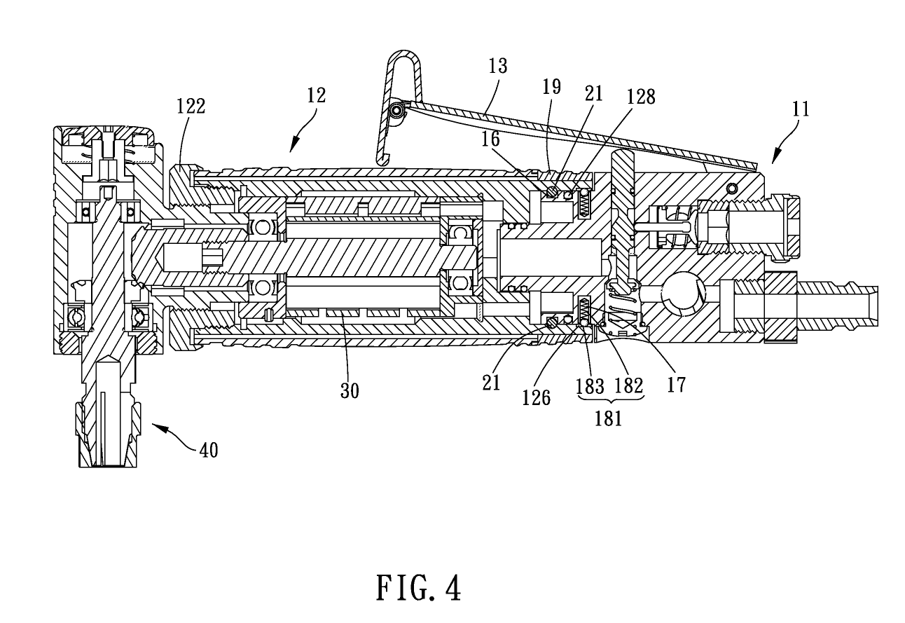

As shown in FIGS. 1 and 4, since urged by the elastic member 182, each stuck member 183 is biased radially outwardly toward the second portion 12 so that each stuck member 183 can engage in one corresponding recess 126 to retain the lever 13 in a position relative to the second portion 12 (above the second portion 12) and the lever 13 does not rotate freely.

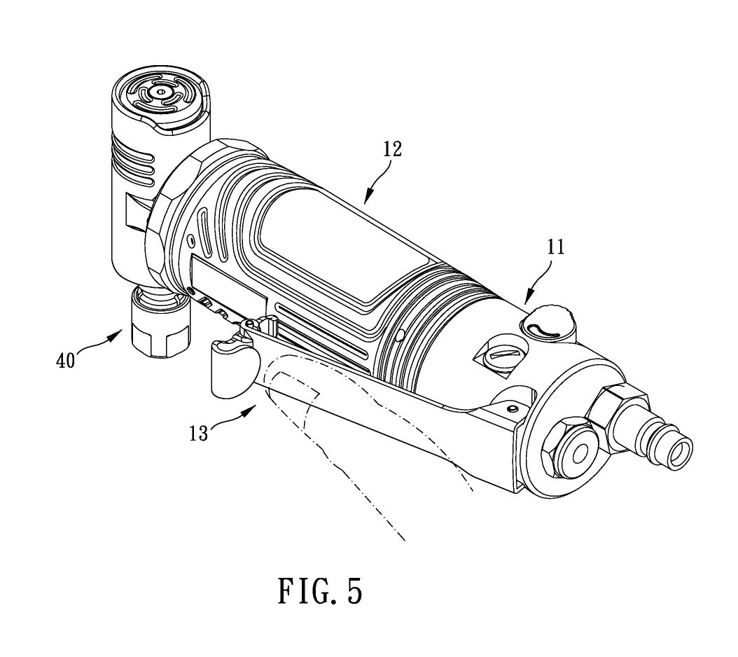

As shown in FIGS. 4 and 5, as the position of the lever 13 should be adjusted (for example, there exists obstruction for pressing the lever 13 in the working environment), it needs to rotate the first portion 11 relative to the second portion 12, wherein since each elastic member 182 is depressible, each stuck member 183 is pushed by a middle wall between two adjacent recesses 126 so as to move indwardly toward each blind hole 17, so that each stuck member 183 can traverse over at least one middle wall and is then stuck in another recess 126; as the relative rotation of the first portion 11 and the second portion 12 is stopped, each stuck member 183 is, again, stuck in a corresponding recess 126, and the lever 13 is positioned in another position (relatively on a left side of the second portion 12).

Given the above, through the two inserts of the connection mechanism disposed through the first portion and partially radially blocked in the annular groove, the first portion is limited by the two inserts, rotatable between the two inserts and relatively rotatably connected to the second portion. Whereby, the lever can be selectively rotated relative to the second portion, and is easy to use and less limited for various working environments.

Furthermore, the first portion and the second portion can be connected with each other via the insert and are rotatable relative to each other, thus resulting in a simple structure and facilitating assembling and disassembling.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A rotatable lever structure of a pneumatic tool, adapted to be mounted to a main body of the pneumatic tool, the main body having a first portion and a second portion, the first portion arranged with a lever and an entrance passage for pressurized air, a connection mechanism detachably mounted to the second portion, and the first portion and the second portion are relatively rotatably connected via the connection mechanism.

2. The rotatable lever structure of claim 1, wherein the first portion is arranged further with an exhaust passage for the pressurized air, an outer circumferential surface of one end of the first portion is formed with an annular groove, and the connection mechanism is partially radially blocked in the annular groove so that the first portion and the second portion are relatively rotatably connected.

3. The rotatable lever structure of claim 2, wherein the second portion include a cylinder, at least one pair of first through holes radially penetrate a circumferential wall of one end of the cylinder, and the connection mechanism includes at least one insert disposed through the first through holes and partially radially blocked in the annular groove.

4. The rotatable lever structure of claim 3, wherein the second portion further includes a sleeve disposed around the cylinder, at least one pair of second through holes radially penetrate a circumferential wall of the sleeve, the insert is disposed through the corresponding first and second through holes and partially radially blocked in the annular groove.

5. The rotatable lever structure of claim 2, wherein a plurality of separate recesses are arranged around on an inner circumferential surface of one end of the second portion, a stuck mechanism is mounted on the outer circumferential surface of the first portion, and the stuck mechanism is radially movably stuck in at least one of the recesses.

6. The rotatable lever structure of claim 5, wherein the outer circumferential surface of the first portion is formed with two blind holes, the stuck mechanism includes two stuck assemblies, each of the stuck assemblies includes an elastic member and a stuck member, the elastic member is received in the blind hole and urges the stuck member to be stuck in one of the recesses.

7. The rotatable lever structure of claim 3, wherein a plurality of separate recesses are arranged around on an inner circumferential surface of one end of the cylinder, a stuck mechanism is mounted on the outer circumferential surface of the first portion, and the stuck mechanism is radially movably stuck in at least one of the recesses.

8. The rotatable lever structure of claim 4, wherein a plurality of separate recesses are arranged around on an inner circumferential surface of one end of the cylinder, a stuck mechanism is mounted on the outer circumferential surface of the first portion, and the stuck mechanism is radially movably stuck in at least one of the recesses.

9. The rotatable lever structure of claim 7, wherein the outer circumferential surface of the first portion is formed with two blind holes, the stuck mechanism includes two stuck assemblies, each of the stuck assemblies includes an elastic member and a stuck member, and the elastic member is received in the blind hole and urges the stuck member to be stuck in one of the recesses.

10. The rotatable lever structure of claim 8, wherein the outer circumferential surface of the first portion is formed with two blind holes, the stuck mechanism includes two stuck assemblies, each of the stuck assemblies includes an elastic member and a stuck member, and the elastic member is received in the blind hole and urges the stuck member to be stuck in one of the recesses.

11. A pneumatic tool, including one of the rotatable lever structure of claim 1, further including:
a main body, having a first portion and a second portion, the first portion arranged with a lever and an entrance passage for pressurized air, and a cylinder being mounted to the second portion;
a rotor, rotatably disposed in the cylinder; and
a tool assembly, rotatably received in the second portion of the main body and in a rotational operative relationship with the rotor;
wherein a connection mechanism is detachably mounted to the second portion, and the first portion and the second portion are relatively rotatably connected via the connection mechanism.

12. A pneumatic tool, including one of the rotatable lever structure of claim 2, further including:
a main body, having a first portion and a second portion, the first portion arranged with a lever and an entrance passage and an exhaust passage for pressurized air, an outer circumferential surface of one end of the first portion formed with an annular groove, and a cylinder mounted to the second portion;
a rotor, rotatably disposed in the cylinder; and
a tool assembly, rotatably received in the second portion of the main body and in a rotational operative relationship with the rotor;
wherein a connection mechanism is detachably mounted to the second portion and partially radially blocked in the annular groove so that the first portion and the second portion are relatively rotatably connected.

13. A pneumatic tool, including one of the rotatable lever structure of claim 5, further including:
a main body, having a first portion and a second portion, the first portion arranged with a lever and an entrance passage and an exhaust passage for pressurized air, an outer circumferential surface of one end of the first portion formed with an annular groove, and a cylinder mounted to the second portion;
a rotor, rotatably disposed in the cylinder; and
a tool assembly, rotatably received in the second portion of the main body and in a rotational operative relationship with the rotor;
wherein a connection mechanism is detachably mounted to the second portion and partially radially blocked in the annular groove so that the first portion and the second portion are relatively rotatably connected.
